(19) United States
(12) Patent Application Publication
(10) Pub. No.: US 2014/0191426 A1
(43) Pub. Date: Jul. 10, 2014

(54) CARBONATED SPRING PRODUCING COUPLER

(71) Applicant: LOTUS PROMOTION LIMITED, Komagane-shi (JP)

(72) Inventor: Hajime Ishikawa, Komagane-shi (JP)

(73) Assignee: LOTUS PROMOTION LIMITED, Komagane-shi (JP)

(21) Appl. No.: 13/978,701

(22) PCT Filed: Jan. 9, 2013
(86) PCT No.: PCT/JP2013/050192

§ 371 Date: Jul. 8, 2013

(51) Int. Cl. B01F 3/04

(52) U.S. Cl. CPC B01F 3/04815
USPC 261/160

(57) ABSTRACT

A carbonated spring producing coupler 100 comprising: a housing 10; a fluid guide path 20 that is formed by an inner wall of the housing 10 and extends in the housing 10; a hot water inlet opening 21 which is provided at one end of the housing 10 to allow the hot water to flow in; a carbon dioxide supply hole 50 for supplying carbon dioxide; a carbonated spring outlet opening 22 which is provided at another end of the housing 10 to discharge the carbonated spring produced by mixing the hot water and the carbon dioxide; a vane member 30 which is provided in the fluid guide path 20. The inner wall of the housing 10 has an inward protrusion 15 that protrudes inwardly. The carbon dioxide supply hole 50 is provided downstream of a farthest protruding vertex of the inward protrusion 15 in a direction in which the hot water flows.

### CROSS REFERENCE TO RELATED APPLICATION

This application is the national stage of International Patent Application no. PCT/JP2013/050192, filed on Jan. 9, 2013, the disclosure of which is incorporated herein in its entirety.

### TECHNICAL FIELD

The present invention relates to a carbonated spring producing coupler that enables carbon dioxide to dissolve in hot water to produce a carbonated spring.

### BACKGROUND ART

Carbonated spring producing devices for producing carbonated springs have been known. As an example of such carbonated spring producing devices, JP 2007-267847 A discloses a carbonated spring producing device that comprises a rotor mechanism, a carbon dioxide gas supply source, and an introduction path. The rotor mechanism includes a rotating drive mechanism attached to one end of a rotary shaft and an impeller attached to the other end of the rotary shaft. The introduction path is for introducing carbon dioxide gas from the carbon dioxide gas supply source toward the rotating region of the impeller. The carbon dioxide gas is introduced by a negative pressure generated by the rotation of the impeller of the rotor mechanism from the carbon dioxide gas supply source through the introduction path to the rotating region of the impeller positioned in hot water.

### SUMMARY OF INVENTION

### Technical Problem

Traditional carbonated spring producing devices such as the one described above, however, are provided with components such as a rotor mechanism, an impeller, and a motor, resulting in excessive size. In addition, traditional carbonated spring producing devices have complex structures because of the need for a drive mechanism such as a motor.

In light of the considerations as described above, the present invention provides a carbonated spring producing coupler that is of a compact size and can produce a carbonated spring easily without using a drive mechanism such as a motor.

### Solution to Problem

A carbonated spring producing coupler according to the present invention comprises:

a housing;

a fluid guide path that is formed by an inner wall of the housing and extends in the housing;

a carbon dioxide supply hole for supplying carbon dioxide to hot water flowing in the fluid guide path; and

a vane member provided in the fluid guide path,

wherein the fluid guide path has a hot water inlet opening and a carbonated spring outlet opening, the hot water inlet opening being configured to allow the hot water to flow in, the carbonated spring outlet opening being configured to discharge a carbonated spring produced by mixing the hot water and the carbon dioxide,

wherein the inner wall of the housing has an inward protrusion that protrudes inwardly, and

wherein the carbon dioxide supply hole is provided downstream of a farthest protruding vertex of the inward protrusion in a direction in which the hot water flows.

Such aspects allow a compact size for a carbonated spring producing coupler and can produce a carbonated spring easily without using a drive mechanism such as a motor.

In a carbonated spring producing coupler according to the present invention,

the carbon dioxide supply hole may be formed through the inward protrusion.

Such aspects allow hot water to take in carbon dioxide immediately after the hot water passes a farthest protruding vertex of an inward protrusion, thereby producing the carbonated spring more efficiently.

In a carbonated spring producing coupler according to the present invention,

the vane member may comprise a first vane member, provided at the hot water inlet opening, and a second vane member, provided at the carbonated spring outlet opening.

Such aspects can further promote dissolving of the carbon dioxide in the hot water.

In a carbonated spring producing coupler according to the present invention,

the first vane member may have a first main body, supported by the hot water inlet opening, and a first vane part, provided in the first main body,

the second vane member may have a second main body, supported by the carbonated spring outlet opening, and a second vane part, provided in the second main body,

the first vane part may be located at the fluid guide path side in relation to the first main body, and

the second vane part may be located at the fluid guide path side in relation to the second main body.

Such aspects can further promote agitation of the hot water inside a fluid guide path, thereby further promoting the dissolving of the carbon dioxide in the hot water.

In a carbonated spring producing coupler according to the present invention,

the vane member may have an internal vane member provided in the fluid guide path upstream of the farthest protruding vertex of the inward protrusion in the direction in which the hot water flows.

Such aspects allow an internal vane member to be provided easily and inexpensively. Such aspects also allow the carbon dioxide to be supplied to the hot water after the agitation by the internal vane member, thereby producing the carbonated spring more efficiently.

### Advantageous Effects of Invention

According to the present invention, an inner wall of a housing has the inward protrusion that protrudes inwardly, and a carbon dioxide supply hole is provided downstream of the farthest protruding vertex of the inward protrusion in a direction in which the hot water flows. This enables the hot water, which has obtained an increased flow rate by passing the inward protrusion, to take in rapidly the carbon dioxide from the carbon dioxide supply hole, thereby producing the carbonated spring automatically.

In addition, a vane member is provided in the fluid guide path in the present invention. This enables the hot water to be agitated when the hot water flows through the vane member, thereby promoting the dissolving of the carbon dioxide in the hot water and producing the carbonated spring more efficiently. In addition, as the hot water and/or the carbonated spring goes through the vane member, the hot water and/or the carbonated spring is agitated. Hence, the present invention can preclude the introduction of a drive mechanism such as a motor and achieve a compact size, thereby producing the carbonated spring easily.

### BRIEF DESCRIPTION OF DRAWINGS

FIG. 1 is a schematic view for describing one aspect of use of a carbonated spring producing coupler according to the present invention.

FIG. 2(a) is a side sectional view of a carbonated spring producing coupler according to a first embodiment of the present invention.

FIG. 2(b) is a view of the carbonated spring producing coupler according to the first embodiment of the present invention observed from the right side of FIG. 2(a).

FIG. 2(c) is a side view of appearance of the carbonated spring producing coupler according to the first embodiment of the present invention.

FIG. 3 is a side sectional view of a carbonated spring producing coupler according to a second embodiment of the present invention.

FIG. 4(a) is a view of an internal vane member of the carbonated spring producing coupler according to the second embodiment of the present invention observed from the left side of FIG. 3.

FIG. 4(b) is a view of the internal vane member observed from the right side of FIG. 3.

### DESCRIPTION OF EMBODIMENTS

### First Embodiment

### Arrangement

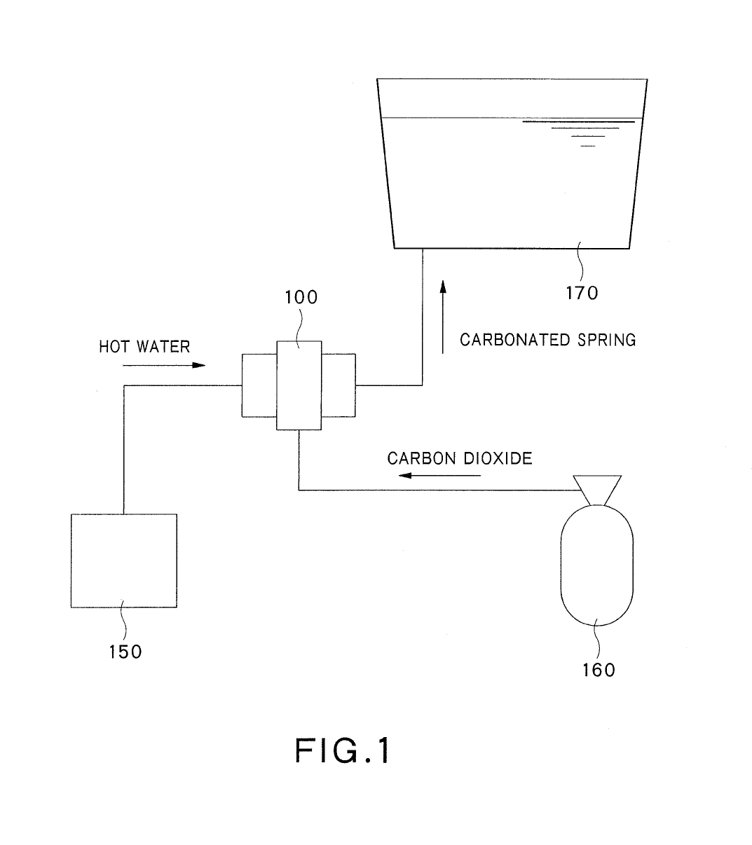

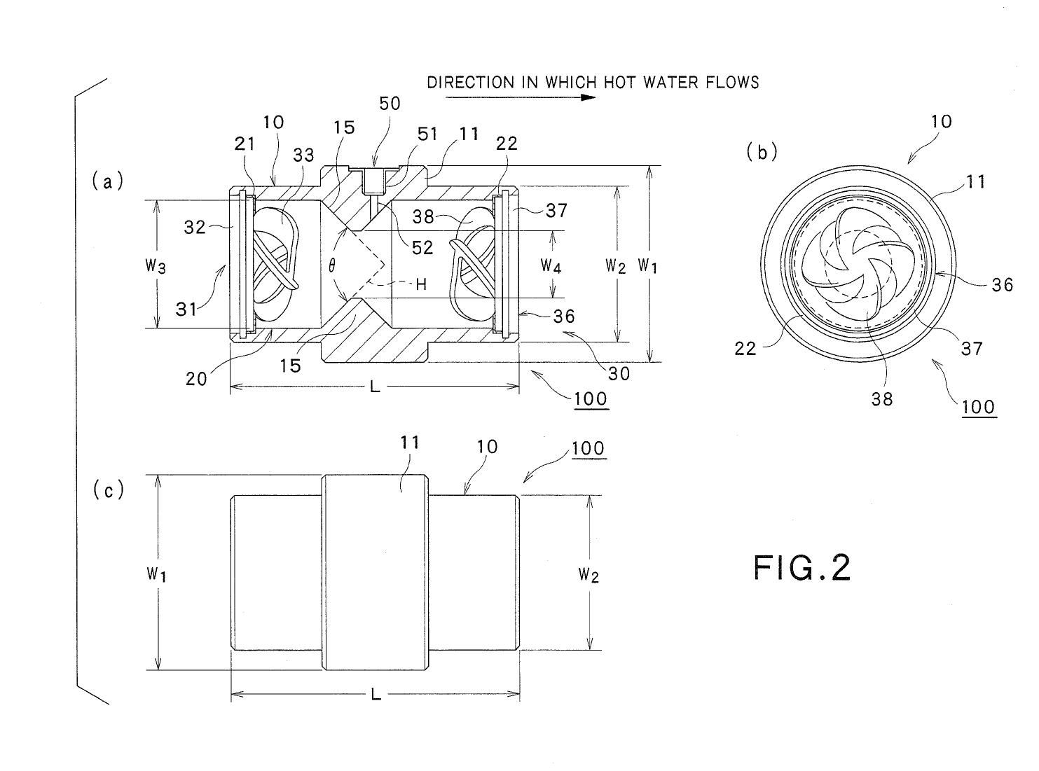

With reference to the drawings, a carbonated spring producing coupler according to a first embodiment of the present invention will now be described. FIG. 1 and FIGS. 2(a) to 2(c) are diagrams for describing the first embodiment of the present invention. As used herein, a carbonated spring refers to a fluid produced with hot water and carbon dioxide dissolved therein. Hot water refers to water having a temperature from 35° C. to 45° C.

As illustrated in FIG. 1, a carbonated spring producing coupler 100 according to the present embodiment is a component for coupling a hot water supply unit 150, which supplies hot water, and a carbon dioxide supply unit 160, which supplies carbon dioxide. The hot water supply unit 150 and the carbon dioxide supply unit 160 are coupled by the carbonated spring producing coupler 100 to a carbonated spring storage unit 170, which is for storing a carbonated spring, such as a bathtub. In this manner, the carbonated spring producing coupler 100 according to the present embodiment is used to store the carbonated spring in the carbonated spring storage unit 170 such as a bathtub. Note that the hot water supply unit 150 is coupled to a hot water inlet opening 21, which is to be described hereinafter, the carbon dioxide supply unit 160 is coupled to a carbon dioxide supply hole 50, which is to be described hereinafter, and the carbonated spring storage unit 170 is coupled to a carbonated spring outlet opening 22, which is to be described hereinafter (see FIG. 2(a)).

As illustrated in FIG. 2(a), the carbonated spring producing coupler 100 according to the present embodiment comprises a housing 10, a fluid guide path 20, the carbon dioxide supply hole 50, and a vane member 30. The housing 10 is made of metal such as stainless steel. The fluid guide path 20 is formed by an inner wall of the housing 10 to extend in the housing 10. The carbon dioxide supply hole 50 is for supplying the carbon dioxide to the hot water flowing in the fluid guide path 20. The vane member 30 is provided in the fluid guide path 20. Note that FIG. 2(a) is a side sectional view of the carbonated spring producing coupler according to the first embodiment of the present invention. FIG. 2(b) is a view of the carbonated spring producing coupler according to the first embodiment of the present invention observed from the right side of FIG. 2(a). FIG. 2(c) is a side view of appearance of the carbonated spring producing coupler according to the first embodiment of the present invention.

As illustrated in FIG. 2(a), the fluid guide path 20 includes the hot water inlet opening 21 and the carbonated spring outlet opening 22. The hot water inlet opening 21 is provided at one end of the housing 10 to allow the hot water to flow in. The carbonated spring outlet opening 22 is provided at another end of the housing 10 to discharge the carbonated spring produced by mixing the hot water and the carbon dioxide.

As illustrated in FIG. 2(a), the inner wail of the housing 10 has an inward protrusion 15 that protrudes inwardly. The carbon dioxide supply hole 50 is provided downstream of a farthest protruding vertex of the inward protrusion 15 in a direction in which the hot water flows. More specifically, the carbon dioxide supply hole 50 is formed through the inward protrusion 15 downstream of the farthest protruding vertex of the inward protrusion 15 in the direction in which the hot water flows.

As illustrated in FIG. 2(a), the vane member 30 according to the present embodiment includes a first vane member 31, provided at the hot water inlet opening 21, and a second vane member 36, provided at the carbonated spring outlet opening 22 (also see FIG. 2(b)).

As illustrated in FIG. 2(a), the first vane member 31 includes a first vane member main body 32 and a first vane part 33. The first vane member main body 32 is supported by the hot water inlet opening 21 and has an opening at a middle thereof. The first vane part 33 is provided in the first vane member main body 32. The second vane member 36 includes a second vane member main body 37 and a second vane part 38. The second vane member main body 37 is supported by the carbonated spring outlet opening 22 and has an opening at a middle thereof. The second vane part 38 is provided in the second vane member main body 37.

The first vane part 33 is located at the fluid guide path 20 side in relation to the first vane member main body 32. The second vane part 38 is located at the fluid guide path 20 side in relation to the second vane member main body 37. That is, the first vane part 33 and the second vane part 38 are positioned in the fluid guide path 20 and face each other.

As illustrated in FIG. 2(a), the carbon dioxide supply hole 50 has a two-step structure and has a first carbon dioxide supply hole 51 and a second carbon dioxide supply hole 52. The first carbon dioxide supply hole 51 has a large diameter and is in communication with the outside of the carbonated spring producing coupler 100. The second carbon dioxide supply hole 52 has a small diameter and is in communication with the fluid guide path 20. The carbonated spring producing coupler 100 has an outer surface that is finished with polishing.

As illustrated in FIGS. 2(a) and 2(c), the carbonated spring producing coupler 100 has an outer diameter protrusion 11, at which an outer diameter of the coupler is increased, at a location corresponding to that of the inward protrusion 15. In a case where a bathtub, for example, is used as the carbonated spring storage unit 170, the outer diameter protrusion 11 has an outer diameter W₁ of, for example, approximately 45 to 55 mm. The carbonated spring producing coupler 100 has an outer diameter W₂ of, for example, approximately 35 to 45 mm at a location outside of the outer diameter protrusion 11. The carbonated spring producing coupler 100 has a length L of, for example, approximately 70 to 75 mm.

In a case where a bathtub, for example, is used as the carbonated spring storage unit 170, the fluid guide path 20 has an inner diameter W₃ of, for example, approximately 30 to 35 mm at a location where the inward protrusion 15 is not formed. The fluid guide path 20 has an inner diameter W₄ of, for example, approximately 15 to 20 mm at the farthest protruding vertex of the inward protrusion 15. In this manner, the ratio of the inner diameter W₄ at the farthest protruding vertex of the inward protrusion 15 to the inner diameter W₃ of the fluid guide path 20 at the location where the inward protrusion 15 is not formed is 1: approximately 1.5 to approximately 2.3.

The inner diameter of the fluid guide path 20 continuously reduces because of the inward protrusion 15. When observed in a longitudinal cross section, an angle θ of an imaginary line H formed by an inner surface of the inward protrusion 15 is approximately 60 degrees to 100 degrees, and is preferably approximately 85 degrees to approximately 95 degrees. Note that the angle θ illustrated in FIG. 2(a) is approximately 90 degrees.

### (Operation and Effect)

An operation and an effect of the present embodiment having the aforementioned arrangement will now be described.

According to the present embodiment, the inner wall of the housing 10 has the inward protrusion 15 that protrudes inwardly, and the carbon dioxide supply hole 50 is provided downstream of the farthest protruding vertex of the inward protrusion 15 in the direction in which the hot water flows. This enables the hot water, which has obtained an increased flow rate by passing the inward protrusion 15, to take in rapidly the carbon dioxide from the carbon dioxide supply hole 50, thereby producing a carbonated spring automatically.

In addition, the vane member 30 is provided in the fluid guide path 20 in the present embodiment. This enables the hot water to be agitated when the hot water flows through the vane member 30, thereby promoting dissolving of the carbon dioxide in the hot water and producing the carbonated spring more efficiently. As the hot water and/or the carbonated spring goes through the vane member 30, the hot water and/or the carbonated spring is agitated. This can preclude the introduction of a drive mechanism such as a motor and achieve a compact size, thereby producing the carbonated spring easily.

In addition, the carbon dioxide supply hole 50 is formed through the inward protrusion 15 in the present embodiment. This enables the hot water to take in the carbon dioxide immediately after the hot water passes the farthest protruding vertex of the inward protrusion 15, thereby producing the carbonated spring more efficiently.

In a case where a bathtub, for example, is used as the carbonated spring storage unit 170, the hot water rich in the carbonated spring can be stored in the bathtub easily and inexpensively. This allows inexpensive introduction of bathing in a carbonated spring. Even a general consumer can enjoy bathing in a carbonated spring inexpensively.

In the present embodiment, in particular, the vane member 30 includes the first vane member 31 provided at the hot water inlet opening 21 and the second vane member 36 provided at the carbonated spring outlet opening 22. In the present embodiment, two vane members 30 are included. This allows the hot water to be agitated by two vane members 30, thereby further promoting the dissolving of the carbon dioxide in the hot water.

In the present embodiment, the first vane part 33 is located at the fluid guide path 20 side in relation to the first vane member main body 32, and the second vane part 38 is located at the fluid guide path 20 side in relation to the second vane member main body 37. This can further promote the agitation of the hot water inside the fluid guide path 20, thereby further promoting the dissolving of the carbon dioxide in the hot water.

In the present embodiment, when the imaginary line H formed by the inner surface of the inward protrusion 15 achieves an acute angle θ of approximately 85 to 95 degrees, the inward protrusion 15 can quicken the flow of the hot water sharply. The hot water, in turn, can increase its power to absorb the carbon dioxide after passing the inward protrusion 15, thereby enabling the carbon dioxide to dissolve in the hot water efficiently.

### Second Embodiment

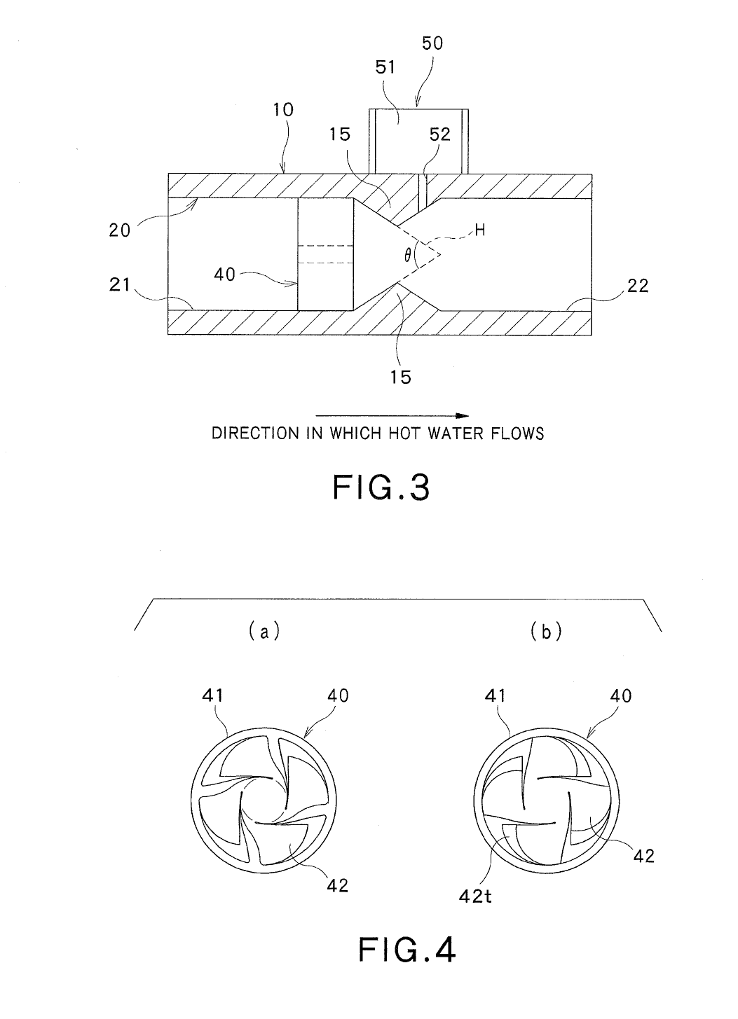

With reference to FIG. 3 and FIGS. 4(a) and 4(b), a second embodiment of the present invention will now be described.

In an aspect of the first embodiment, the vane member 30 includes the first vane member 31 at the hot water inlet opening 21 and the second vane member 36 at the carbonated spring outlet opening 22. In an aspect of the second embodiment, a vane member 30 includes an internal vane member 40 provided in the fluid guide path 20 upstream of a farthest protruding vertex of an inward protrusion 15 in a direction in which hot water flows.

As illustrated in FIGS. 4(a) and 4(b), the internal vane member 40 includes an internal vane member main body 41, which is annular, and an internal vane part 42. The internal vane part 42 is provided in the annular inside of the internal vane member main body 41. Note that FIG. 4(a) is a view of the internal vane member 40 of FIG. 3 observed from the upstream side in the direction in which the hot water flows (the left side of FIG. 3). FIG. 4(b) is a view of the internal vane member 40 of FIG. 3 observed from the downstream side in the direction in which the hot water flows (the right side of FIG. 3).

In addition, in the aspect illustrated in FIGS. 3, 4(a), and 4(b), the internal vane part 42 has an edge 42t that faces the downstream side in the direction in which the hot water flows.

Other components in the second embodiment have a substantially similar aspect to the first embodiment. In the second embodiment, components similar to those in the first embodiment are given like reference characters and the detailed description therefor will not be repeated.

The present embodiment can provide a similar effect to the first embodiment. Since the detailed description has been provided in the first embodiment, particularly important effects of the present embodiment will now be described.

According to the present embodiment, an inner wall of a housing 10 has an inward protrusion 15 that protrudes inwardly, and a carbon dioxide supply hole 50 is provided downstream of a farthest protruding vertex of the inward protrusion in the direction in which the hot water flows. This enables the hot water, which has obtained an increased flow rate by passing the inward protrusion 15, to take in rapidly carbon dioxide from the carbon dioxide supply hole 50, thereby producing a carbonated spring automatically.

In addition, the internal vane member 40 is provided in a fluid guide path in the present embodiment. This enables the hot water to be agitated when the hot water passes through the internal vane member 40 in the fluid guide path 20, thereby promoting dissolving of the carbon dioxide in the hot water and producing the carbonated spring more efficiently. As the hot water and/or the carbonated spring passes through the internal vane member 40, the hot water and/or the carbonated spring is agitated. This can preclude the introduction of a drive mechanism such as a motor and achieve a compact size, thereby producing the carbonated spring easily.

In addition, the carbon dioxide supply hole 50 is formed through the inward protrusion 15 in the present embodiment. This enables the hot water to take in the carbon dioxide immediately after the hot water passes the farthest protruding vertex of the inward protrusion 15, thereby producing the carbonated spring more efficiently.

In addition, the internal vane member 40 is provided upstream of the farthest protruding vertex of the. inward protrusion 15 in the direction in which the hot water flows in the present embodiment. Hence, the internal vane member 40 can be stopped by the inward protrusion 15 without a component provided to secure the internal vane member 40, and thus the internal vane member 40 can be retained in the fluid guide path 20. This allows the internal vane member 40 to be provided easily and inexpensively.

In addition, the internal vane member 40 is provided upstream of the farthest protruding vertex of the inward protrusion 15 in the direction in which the hot water flows as described above. This enables the carbon dioxide to be supplied to the hot water after the agitation by the internal vane member 40, thereby producing the carbonated spring more efficiently.

Here, according to the aspect of the present embodiment, free carbon dioxide was found to dissolve in water of pH 4.0 at 13° C. at 2000 mg/l, free carbon dioxide was found to dissolve in tap water of pH 4.3 at 38° C. at 1030 mg/l, and free carbon dioxide was found to dissolve in hot water of pH 4.5 at 40° C. at 980 mg/l.

The embodiments described and the drawings disclosed herein are intended for purposes of illustration only to describe the scope of the present invention. The embodiments described and the drawings disclosed herein are not intended to limit the scope of the present invention.

### REFERENCE SIGNS LIST

10 Housing
15 Inward protrusion
20 Fluid guide path
21 Hot water inlet opening
22 Carbonated spring outlet opening
30 Vane member
31 First vane member
32 First vane member main body
33 First vane part
36 Second vane member
37 Second vane member main body
38 Second vane part
40 Internal vane member
41 Internal vane member main body
42 Internal vane part
50 Carbon dioxide supply hole
100 Carbonated spring producing coupler

1. A carbonated spring producing coupler comprising:
a housing;
a fluid guide path that is formed by an inner wall of the housing and extends in the housing;
a carbon dioxide supply hole for supplying carbon dioxide to hot water flowing in the fluid guide path; and
a vane member provided in the fluid guide path,
wherein the fluid guide path has a hot water inlet opening and a carbonated spring outlet opening, the hot water inlet opening being configured to allow the hot water to flow in, the carbonated spring outlet opening being configured to discharge a carbonated spring produced by mixing the hot water and the carbon dioxide,
wherein the inner wall of the housing has an inward protrusion that protrudes inwardly, and
wherein the carbon dioxide supply hole is provided downstream of a farthest protruding vertex of the inward protrusion in a direction in which the hot water flows.

2. The carbonated spring producing coupler according to claim 1, wherein the carbon dioxide supply hole is formed through the inward protrusion.

3. The carbonated spring producing coupler according to claim 1, wherein the vane member comprises a first vane member, provided at the hot water inlet opening, and a second vane member, provided at the carbonated spring outlet opening.

4. The carbonated spring producing coupler according to claim 3, wherein the first vane member has a first main body, supported by the hot water inlet opening, and a first vane part, provided in the first main body,
wherein the second vane member has a second main body, supported by the carbonated spring outlet opening, and a second vane part, provided in the second main body,
wherein the first vane part is located at the fluid guide path side in relation to the first main body, and
wherein the second vane part is located at the fluid guide path side in relation to the second main body.

5. The carbonated spring producing coupler according to claim 1, wherein the vane member has an internal vane member provided in the fluid guide path upstream of the farthest protruding vertex of the inward protrusion in the direction in which the hot water flows.

6. The carbonated spring producing coupler according to claim 2, wherein the vane member comprises a first vane member, provided at the hot water inlet opening, and a second vane member, provided at the carbonated spring outlet opening.

7. The carbonated spring producing coupler according to claim 6, wherein the first vane member has a first main body, supported by the hot water inlet opening, and a first vane part, provided in the first main body,
wherein the second vane member has a second main body, supported by the carbonated spring outlet opening, and a second vane part, provided in the second main body,
wherein the first vane part is located at the fluid guide path side in relation to the first main body, and
wherein the second vane part is located at the fluid guide path side in relation to the second main body.
